(19) United States
(12) Patent Application Publication
(10) Pub. No.: US 2016/0048660 A1
(43) Pub. Date: Feb. 18, 2016

(54) REPORT GENERATION BASED ON REAL-TIME AND HISTORICAL DATA

(71) Applicant: Consilink, LLC, Chicago, IL (US)

(72) Inventors: Cheryl Lulias, Evanston, IL (US); Kasu Sista, Oak Brook, IL (US); Annabelle E. Lim-Greene, Chicago, IL (US)

(21) Appl. No.: 14/506,539

(22) Filed: Oct. 3, 2014

Related U.S. Application Data
(60) Provisional application No. 62/037,830, filed on Aug. 15, 2014.

(51) Int. Cl. G06F 19/00

(52) U.S. Cl. CPC G06F 19/3487; G06F 19/322

(57) ABSTRACT

Provided is a system including a data analytics module that is configured to process aggregated patient data to generate a report comprising relevant patient activities identified using a calculated relevance score. The aggregated patient data for each patient of a plurality of patients comprises historical data associated with a respective patient and recent patient activity associated with the respective patient received from electronic devices associated with a number of healthcare organizations. The recent patient activities are non-claim-based activities from a number of healthcare organizations received from the electronic devices associated with the plurality healthcare organizations. The system also includes a messaging module that is configured to transmit the report to an electronic device associated with one or more of the healthcare organizations responsive to the report generation.

### RELATED APPLICATIONS

This application claims the benefit of and priority to U.S. provisional patent application No. 62/037,830, titled “REPORT GENERATION BASED ON REAL-TIME AND HISTORICAL DATA”, by Cheryl Luilas et al., and filed on Aug. 15, 2014. The priority application is incorporated by reference herein.

### BACKGROUND

Healthcare delivery is a patchwork of different healthcare providers, e.g., primary care providers (PCP), hospitals, medical homes, health insurance providers, etc., all providing different services to patients. This patchwork leads to a lack of coordination between the healthcare providers, ultimately impacting their ability to attend to the needs of their patients. In addition, with implementation of the Affordable Care Act (ACA), healthcare providers are being rated based on outcome-based results. Consequently, healthcare providers are incentivized to provide higher quality healthcare that is outcome driven at a lower cost.

### SUMMARY

Accordingly, a need has arisen for a solution to improve patient care by reducing unnecessary hospital readmissions, inappropriate hospitalizations, poor chronic care management, and preventable emergency department visits. Further, there is a need to better leverage computing technology as a way of driving better coordination between healthcare providers and lowering treatment and delivery costs. For example, an information coordination system may be used to aggregate data stored by the different healthcare providers and portions of the aggregated data may be provided to the relevant healthcare providers to coordinate healthcare treatment and delivery. The aggregated data may be used in conjunction with near real-time information to track patient activity and to generate a report that may be provided to the relevant healthcare providers.

According to some embodiments, historical data associated with a patient and recent patient activity associated with the patient is received. The historical data and the recent patient activity are processed to generate a report comprising recent patient activities based on a ranking. The report is then transmitted to one or more of a number of healthcare organizations of the patient.

According to some embodiments, a data store module is configured to store patient data associated with a number of patients from a memory storage. The patient data for each patient includes historical data associated with a respective patient and recent patient activity associated with the respective patient. The recent patient activities are from a number of healthcare organizations and are non-claim based. A data analytics module is configured to process the patient data to generate a report comprising recent patient activities that are actionable by the healthcare organizations. A messaging module is configured to transmit the report to one or more of the healthcare organizations.

According to some embodiments, aggregated patient data associated with a plurality of patients is received from a memory storage. The aggregated patient data for each patient includes historical data associated with a respective patient and recent patient activity associated with the respective patient. The recent patient activities are from a number of healthcare organizations and are non-claim based. The aggregated patient data is processed to generate a report including recent patient activities that are actionable by the healthcare organizations. The report is transmitted to one or more of the healthcare organizations.

These and other features and aspects may be better understood with reference to the following drawings, description, and appended claims.

### BRIEF DESCRIPTION OF DRAWINGS

FIGS. 1A-F illustrate operating environments according to some embodiments.

FIG. 2 illustrates a data flow diagram according to some embodiments.

FIG. 3 illustrates data interactions within an information coordination system according to some embodiments.

FIGS. 4A-4B illustrate reports displayed on a graphical user interface according to some embodiments.

FIGS. 5-6 illustrate a wireframe of alert reports displayed on a graphical user interface according to some embodiments.

FIG. 7 illustrates a clinic referral according to some embodiments.

FIG. 8 illustrates a flow chart diagram for generating a report according to some embodiments.

FIG. 9 illustrates another flow chart diagram for generating a report according to some embodiments.

FIG. 10 illustrates a computer system according to some embodiments.

FIG. 11 illustrates a block diagram of another computer system according to some embodiments.

### DETAILED DESCRIPTION

Reference will now be made in detail to various embodiments, examples of which are illustrated in the accompanying drawings. While the claimed embodiments will be described in conjunction with various embodiments, it will be understood that these various embodiments are not intended to limit the scope of the embodiments. On the contrary, the claimed embodiments are intended to cover alternatives, modifications, and equivalents, which may be included within the scope of the appended Claims. Furthermore, in the following detailed description, numerous specific details are set forth in order to provide a thorough understanding of the claimed embodiments. However, it will be evident to one of ordinary skill in the art that the claimed embodiments may be practiced without these specific details. In other instances, well known methods, procedures, components, and circuits are not described in detail so that aspects of the claimed embodiments are not obscured.

Some portions of the detailed descriptions that follow are presented in terms of procedures, logic blocks, processing, and other symbolic representations of operations on data bits within a computer memory. These descriptions and representations are the means used by those skilled in the data processing arts and data communication arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical or magnetic signals capable of being stored, transferred, combined, compared, and otherwise manipulated in a computer system or computing device. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “receiving,” “aggregating,” “transmitting,” “accessing,” “rendering,” “determining,” or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

It is appreciated that present systems and methods can be implemented in a variety of architectures and configurations. For example, present systems and methods can be implemented as part of a distributed computing environment, a cloud computing environment, a client server environment, etc. Embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular abstract data types. The functionality of the program modules may be combined or distributed as desired in various embodiments.

Computer storage media can include volatile and nonvolatile, removable and non-removable media implemented in any method or technology for storage of information such as computer-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

With the implementation of the Affordable Care Act (ACA), healthcare has become outcome based or accountable based on the quality of treatment. For example, hospitals are penalized for patient readmissions within 30 days, whether the original admission was by the same hospital or a different hospital. As a result, healthcare providers are looking to improve efficiency, effectiveness, and quality of patient care.

In some embodiments, patients are assigned to particular healthcare providers, e.g. PCP, clinics, hospitals, etc., for their healthcare needs. However, should a patient visit a different healthcare provider, e.g., PCP, clinic, hospital, etc., the assigned healthcare provider has no way of being notified of this recent activity because the clinics and the hospitals are disparate healthcare organizations and do not share information with one another. In other words, healthcare providers maintain and keep “longitudinal data” without sharing it between different providers. Accordingly, appropriate steps cannot be taken to improve patient care and reduce readmission rates, e.g., at hospitals.

Provided herein are embodiments for aggregating patient data that is generated by disparate healthcare organizations. The aggregated patient data from disparate healthcare organizations is stored for later retrieval by an information coordination system, in one instance. In some embodiments, patient data from non-disparate healthcare organizations may also be aggregated and stored for later retrieval. Relevant information from the aggregated patient data may be transmitted to other providers (e.g., clinics (assigned or not), hospitals, etc.), in order to improve patient care (e.g., by the assigned clinic making follow up appointments after a hospital visit, by reminding the patient to pick up medication, assigning and referring the patient to a clinic if the patient is not assigned to a clinic, etc.). As a result, care coordination between healthcare providers and patients becomes more effective, and in turn improves healthcare quality and reduces cost by reducing readmission rates. Furthermore, reducing unnecessary readmission rates reduces health care providers' financial penalties, thereby increasing profits.

Furthermore, any references to hospitals, clinics, etc. are references to their computers, servers, electronic devices, etc., that store electronic information. Although this disclosure illustrates and describes interaction between healthcare entities and an information coordination system, this disclosure contemplates and includes the interactions between any suitable electronic devices of the healthcare entities with any suitable electronic devices of the information coordination system, for example, desktop computers or tablets at hospitals communicating with a hospital storage device or a clinic storage device communicating with a server of the information coordination system. Such interactions are contemplated throughout the disclosure. Any references to servers of the healthcare entities or information coordination system are exemplary and contemplates the use of any suitable electronic device such as a single-board computer system (SBC), for example computer-on-module (COM) or system-on-module (SOM), a laptop or notebook computer system, a mobile telephone, a smartphone, a personal digital assistant (PDA), a tablet computer system, etc.

It is appreciated that patient information may include but is not limited to historical prescription and medical claims data, patient diagnosis, patient diseases, physical examination, etc. In some embodiments, patient information may include “real-time alerts” associated with patient hospital activity, e.g., patient visiting a hospital complaining about a headache, patient being admitted to a hospital, patient visiting a hospital complaining about chest pains and lab works ordered for the chest pain, etc. It is appreciated that “real-time alerts” may be literally real time or near real time, e.g., within hours of patient visit. It is appreciated that embodiments described with respect to patient information is not limited to specific medical information and the use of specific medical information is for illustrative purposes. As such, using specific medical information as illustrated by the accompanying figures are illustrative and non-limiting. For example, any type of information associated with a patient may be used, e.g., biometric information, social services information, patient feedback data, etc., may also be used

Relevant information from the aggregated patient data may be transmitted to other providers, e.g., clinics (assigned or not), hospitals, etc., in order to improve patient care, e.g., by the assigned clinic making follow up appointments after a hospital visit, by reminding the patient to pick up medication, assigning and referring the patient to a clinic if the patient is not assigned to a clinic, etc. As a result, care coordination between healthcare providers and patients becomes more effective, and in turn improves healthcare quality and reduces costs by reducing the hospital readmission rates. Furthermore, profit for hospital will increase because reducing unnecessary readmission rates reduces their penalty, thereby increasing their profit.

In some embodiments, the transfer of data may be implemented through a web-based portal. As another example, the information coordination system and/or the assigned clinic may transmit reminders to patients who had a recent hospital stay or visit to the emergency department (ED) to perform follow-up visits with their clinic or clinic. Herein, reference to healthcare entities may refer to hospitals, centers for Medicare and Medicaid Services (CMS), States, clinics, health-information exchanges, Insurance companies, payors, etc. that provide healthcare services to patients. It is appreciated that the aggregated patient data may be transmitted to a server of a healthcare entity, whilst the aggregated patient data may be further transmitted to lower level providers of service within the healthcare entity that performs the actual intervention. For example, a relevant portion of aggregated patient data or report may be transmitted a PCP, rendering provider, prescribing physician, etc. Additionally, reference to near real-time data may refer to data that is separate from medical claims data obtained from CMS or health information exchanges, such that transmission or reception of data from a first computing system within a period of time (e.g., thirty minutes, an hour, etc.) of the data being entered into a second computing system.

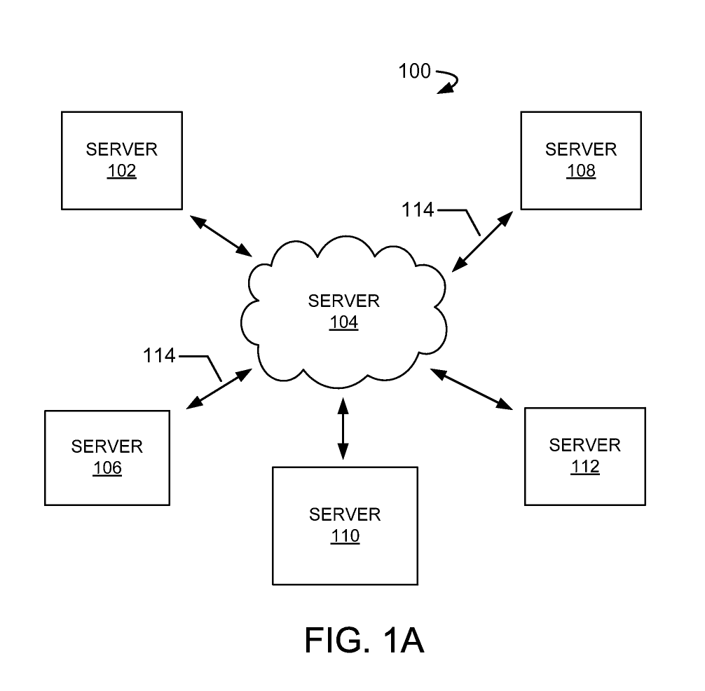

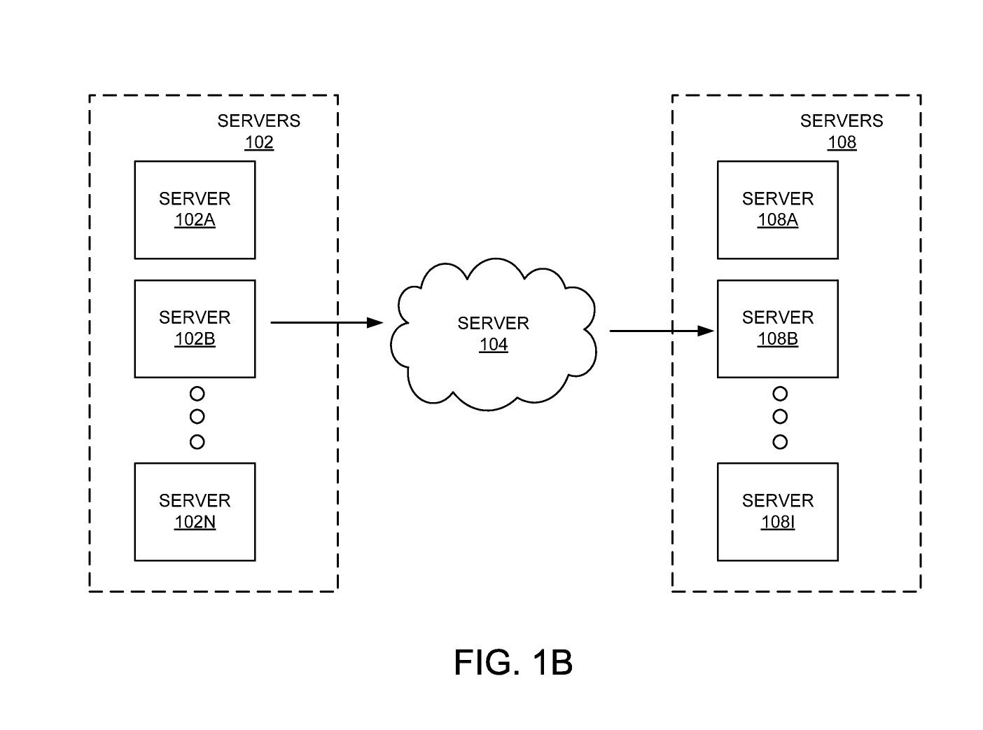

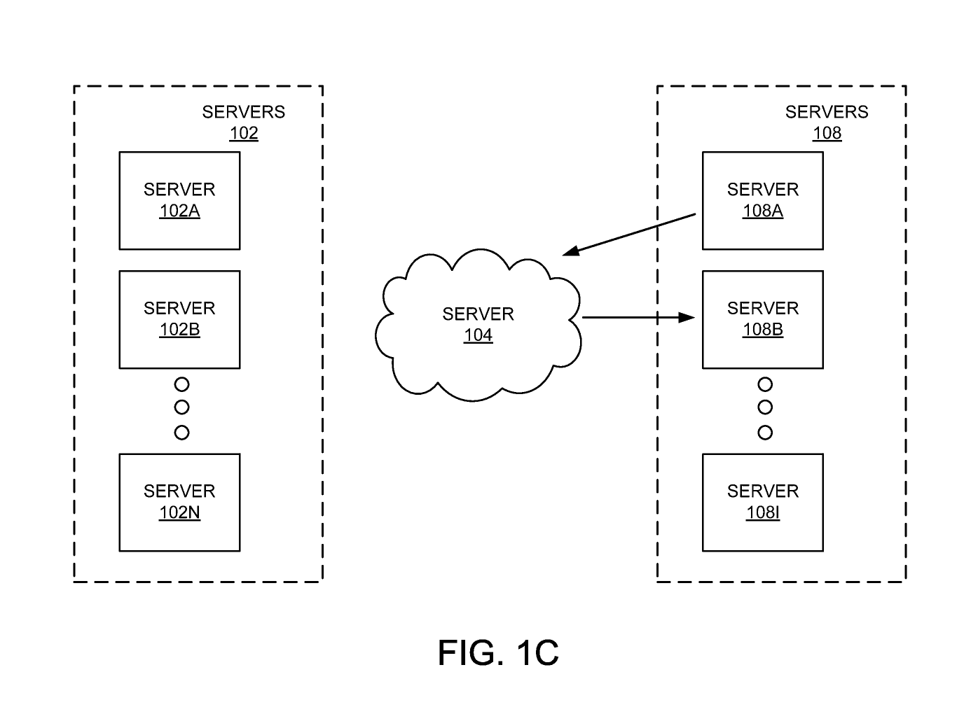

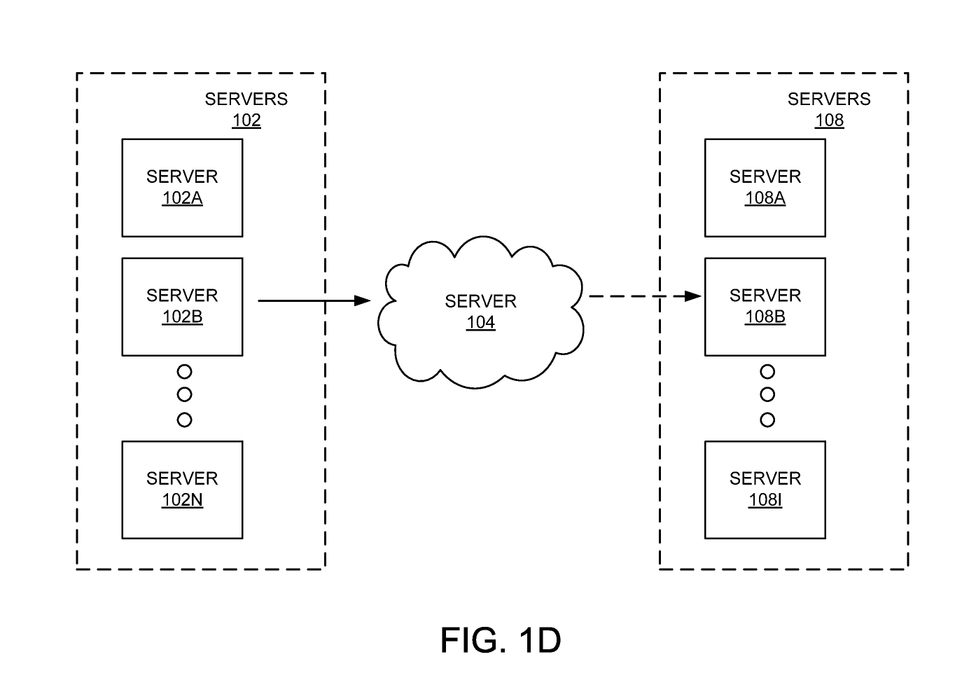

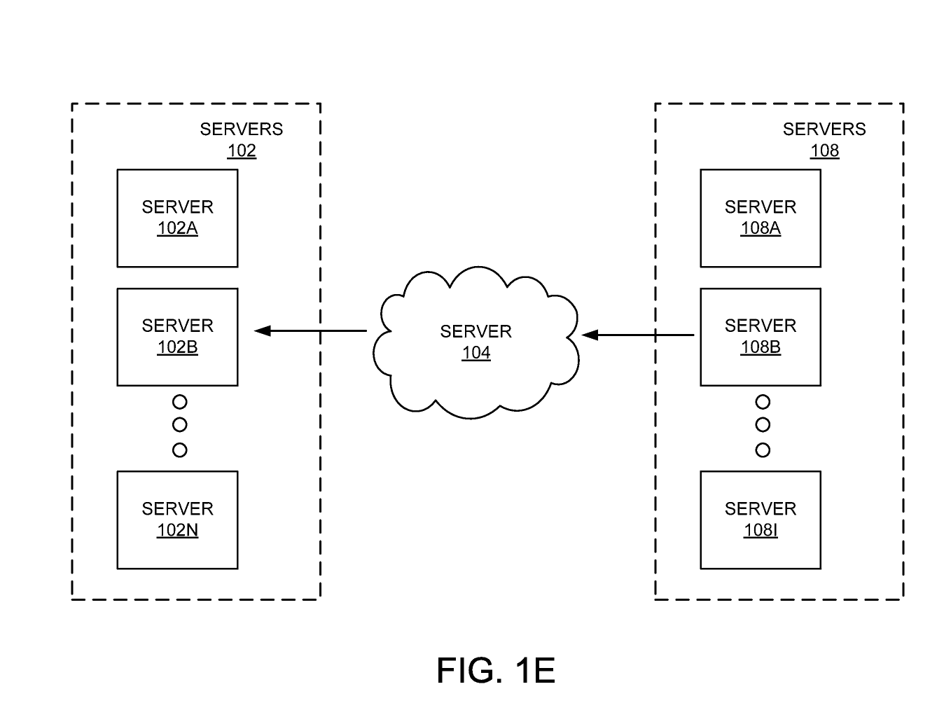

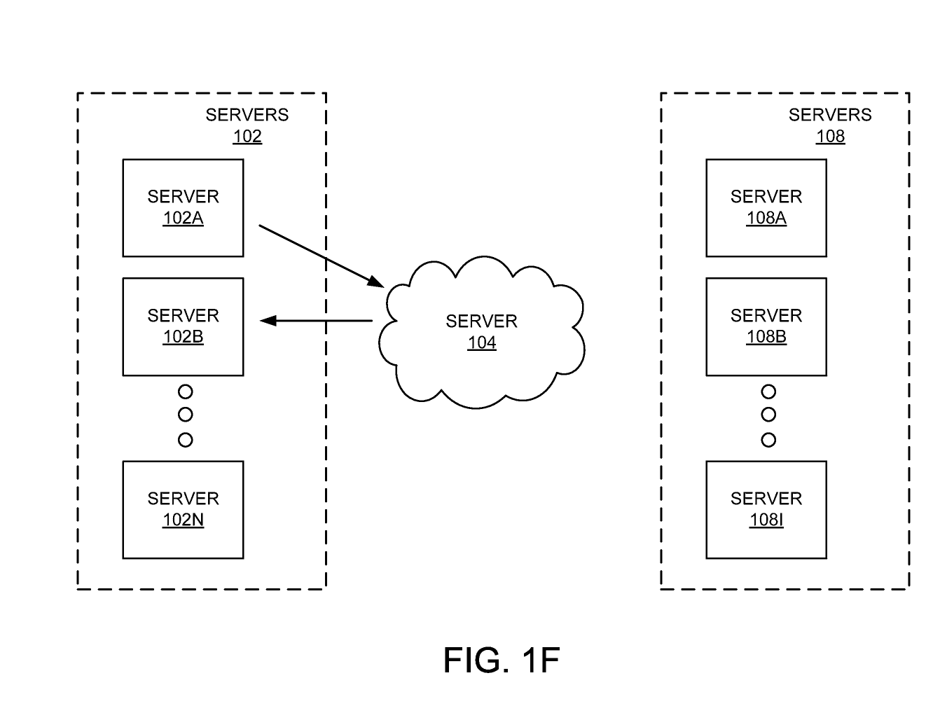

FIGS. 1A-D illustrate operating environments according to some embodiments. Operating environment 100 may include a number of servers 102-112 in communication with servers of an information coordination system. Servers 102 correspond to servers at hospitals, servers 104 to servers of an information coordination system, servers 106 to CMS servers, servers 108 to clinic servers, servers 110 to health information exchange servers, and servers 112 to patient servers. It is appreciated that the operating environment 100 may also include health insurance companies, payors, etc., (not shown). Patients may receive healthcare services from one or more hospitals, CMS, and/or clinics. Furthermore, over a lifetime, individual patients may have, for example, used multiple hospitals, health information exchanges, or clinics. For example, patients may have used multiple clinics if they have moved or changed their health insurance provider. As described herein, information coordination system aggregate data stored by the different healthcare providers, e.g., disparate healthcare entities, regarding a patient. It is appreciated that the aggregated patient data may include but is not limited to historical prescription and medical claims data, patient diagnosis, patient diseases, physical examination, etc. In some embodiments, aggregated patient information may include “real-time alerts” associated with patient hospital activity, e.g., patient visiting a hospital complaining about a headache, patient being admitted to a hospital, patient visiting a hospital complaining about chest pains and lab works ordered for the chest pain, etc.

The aggregated information by the information coordination system may be used to generate a report for appropriate healthcare provider, e.g., assigned clinic. The report may be used by the appropriate healthcare provider, e.g., assigned clinic, to better understand the medical situation of a patient and to tailor medical care and treatment to improve patient care, e.g., by setting up a follow up visit, by reminding the patient to pick up medication, etc. In other words, portions of the aggregated data may be used by the information coordination system to generate a relevant report and may be provided to the relevant healthcare providers, e.g., assigned clinic, to coordinate healthcare treatment.

Hospitals, CMS, clinics, health information exchange, may each include multiple entities or be a combination of multiple types of entities (e.g., hospitals or clinics). Hospitals are healthcare entities whose services may include after-hours and/or specialized treatment for a variety of patient ailments or treatment for more serious patient ailments requiring immediate attention. As an example, the ED of hospitals may provide treatment to patients for conditions that require immediate attention. In some embodiments, hospitals may provide near real-time data on patient activities to information coordination system. For example hospital admission, discharge, transfer data (e.g., from the ED to internal medicine), patient visiting a hospital complaining about a headache, patient being admitted to a hospital, patient visiting a hospital complaining about chest pains and lab works ordered for the chest pain, medication ordered, etc., may be received by information coordination system 104 in near real-time. As described above, near real-time data reception of data from a computing system of a healthcare entity to information coordination system within a short period of time (e.g., an hour or a day) compared to adjudicated medical claim data provided by servers 106 of CMS or health information exchange, which is in the order of weeks or months old. As an example, near real-time data from servers 102 of hospitals may be received within a range of approximately 5 hours to 24 hours of patient activity. As another example, near real-time data from clinics may be received within a range of 1 day to 2 days of a change in a care plan of patients being entered into a server of clinics. As another example, patient data may further include prescription data. In other embodiments, servers 102 of hospitals may provide non-claim based data, for example diagnosis (DX) summaries or ED notes in the form of a patient's electronic health record (EHR). An EHR is a digital version of the patient's paper hospital chart. As another example patient data may include data collected via remote monitoring devices and/or surveys administered in the field.

Clinics are healthcare entities, for example clinics, that provide out-patient preventative or follow-up treatment to patients. For example, healthcare professionals at clinics may perform yearly laboratory (“lab”) work and check-up with patients to determine the general health status and provide any necessary preventative treatment, for example design long-care plans or diagnose chronic problems (e.g., hypertension). In some embodiments, patients that sign up for Medicare or Medicaid may be automatically assigned to one of the clinics, such that data of patients may be provided to information coordination system by clinics that are a part of operating environment 100. In addition, clinics may be responsible for follow-up care of patients after a hospital stay or visit to an ED. Furthermore, within each clinics are PCPs whom the patients are assigned for overall care, servicing, or rendering providers of the actual services, prescribing physicians, as well as other associated type services, e.g., lab, radiology, etc.

CMS administers public health insurance plans (e.g., Medicare) and health information exchange private (e.g., CIGNA) health insurance plans by processing claims and distributing reimbursements for treatment provided by one or more healthcare entities, for example hospitals or clinics. CMS is a Federal agency that administers Medicare and, in conjunction with states, Medicaid. In some embodiments, CMS or health information exchange may provide a patient's insurance eligibility, medical prescription (Rx), or insurance claim data to servers 104 of information coordination system. In some embodiments, patients signing up for Medicaid or Medicare creates a patient record at servers 106 of CMS. In other embodiments, patients signing up for private healthcare insurance through an insurance exchange create a patient record at servers 110 of health information exchange. The patient records stored by servers 106 of CMS or servers 110 of health information exchange may include health insurance eligibility data or claim information that is accessible by servers 104 of information coordination system.

As described above, servers, e.g., 102, may be communicatively coupled to server 104 of information coordination system through network 114. Network 114 may include more than one network (e.g., intranets, the Internet, local area networks (LANs), wide area networks (WANs), etc.) and may be a combination of one or more networks including the Internet or web-based portals. While the disparate healthcare entities, for example servers 102 of hospitals or servers 108 of clinics, may be communicatively coupled to servers 104 information coordination system, the servers of the disparate healthcare entities are not in communication with each other. In other words, data of patients are stored in isolated systems or silos maintained by the different healthcare entities. In some embodiments, data exchange between servers 104 information coordination system 104 and servers, e.g., 102 or 108, of the disparate healthcare entities, for example hospitals or clinics, through a web-based connector portal is provided. In other embodiments, data exchange between servers 104 of information coordination system and the disparate healthcare entities may be performed through paper output, text, email, phone call, etc.

As illustrated in the FIGS. 1B-F, servers 102 may correspond to servers 102A-N of multiple hospitals and servers 108 may correspond to servers 108A-I of multiple clinics. Furthermore, servers 102A-N of each hospital and servers 108A-I of each clinic may be communicatively coupled to servers 104 of the information coordination system. In one example, a patient may be assigned to a clinic (server 108B) for primary care. The patient may be admitted to the ED of hospital (server 102B) and as a result, this activity is received by server 104 of information coordination system. Server 104 of Information coordination system may determine the patient is assigned to clinic (server 108B) and transmit an alert or notification to clinic (server 108B), as illustrated in FIG. 1B.

In another example, a patient may be assigned to clinic (server 108B) for primary care, but may be treated clinic (server 108A) for a medical condition that the assigned clinic (server 108B) is ill-equipped to treat. This activity is received by server 104 of information coordination system and based on the patient data, transmit an alert or notification of the activity to clinic (server 108B), as illustrated in FIG. 1C. In yet another example, a patient may not be assigned to a clinic, but may be treated at the ED of hospital (server 102B) for a medical condition. This activity is received by server 104 of information coordination system and based on the patient data, server 104 of information coordination system may transmit a referral form to the patient for follow-up care at clinic (server 108B) and the patient information to clinic (server 108B), as illustrated in FIG. 1D.

As illustrated in FIG. 1E, a patient may be assigned to clinic (server 108B), where clinic (server 108B) has been overseeing the long-term care of the patient, including performing annual check-ups and supervision medications for any chronic conditions. Server 104 of information coordination system may receive the patient information from clinic (server 108B) that includes the long-term care plans of the patient. The patient may go to the maternity department of hospital (server 102B) to perform a delivery. Information related to admission of the patient to the maternity department of hospital (server 102B) is received by server 104 of information coordination system. Server 104 of information coordination system may send the long-term care information originally stored at clinic (server 108B) to hospital (server 102B), such that the physicians for the maternity department are able to determine if the any chronic conditions or medications being taken by the patient warrant special attention.

As illustrated in FIG. 1F, a patient may visit the ED of hospital (server 102A) for treatment for head trauma from an automobile accident. Hospital (server 102A) may be the closest to the scene of the accident, but due to its size may lack some diagnostic equipment present at larger hospitals. The physicians attending the patient at hospital (server 102A) may be unable to properly extent of the head trauma of the patient due to not having the proper equipment. For this reason, the patient may be transferred to another hospital (server 102B) that is better equipped to evaluate the patient. Server 104 of information coordination system may receive the patient information from hospital (server 102A) that includes any preliminary diagnosis and medical procedures performed at the ED of hospital (server 102A), as well as the information that the patient is being transferred. Server 104 of information coordination system may send the patient information received from hospital (server 102A) and send the patient information to the neurological department of hospital (server 102B), such that the neurologists at hospital (server 102B) have the most current medical information of the patient.

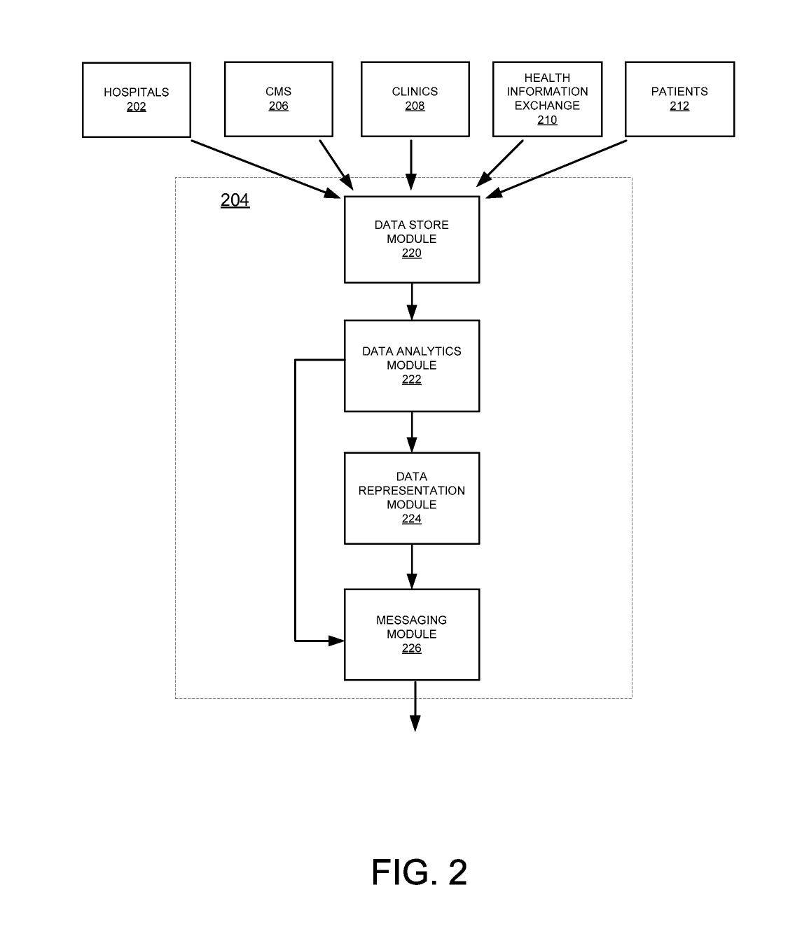

FIG. 2 illustrates a data flow diagram according to some embodiments. Information coordination system 204 is configured to receive and transmit data to and from hospitals 202, CMS 206, clinics 208, health-information exchange 210, and patients 212. Hospitals 202, information coordination system 204, CMS 206, clinics 208, health-information exchange 210, and patients 212 are similar to hospitals 102, information coordination system 104, CMS 106, clinics 108, health-information exchange 110, and patients 112, respectively, and operate substantially similarly thereto. As described above, information coordination system 204 is configured to aggregate data from the disparate healthcare entities and facilitate the timely exchange of information between healthcare entities to improve healthcare quality with higher efficiency. In some embodiments, information coordination system 204 may include a data store module 220, data analytics module 222, data representation module 224, and messaging module 226. Data store module 220, data analytics module 222, data representation module 224, and messaging module 226 may be executed on one or more computing systems (e.g., virtual or physical computing systems).

Data store module 220 may be part of or stored in a data warehouse. In some embodiments, data from hospitals 202, CMS 206, clinics 208, health-information exchange 210, and patients 212 may be stored in data store module 220 as part of one or more databases. The stored data may be stored hierarchically where each entry may have one or more sub-entries. For example, entries in the data structure may correspond to the individual patients 212 (e.g., patient's name) and the sub-entries may be the data of the individual patients 212, e.g., patient diagnosis, age, gender, medication, assigned clinic, etc. The data structure may include data of patients obtained from hospitals 202, CMS 206, clinics 208, health-information exchange 210, and the patients themselves. In some embodiments, the data structure of patients 212 may be organized in a hierarchy of clinics 208 and hospitals 202 based on the particulars of each patient 212 (e.g., medical treatments, type of medical coverage, etc.). In some embodiments, data store module 220 may be implemented using database software as a service (dbSaaS).

Clinics 208 may send data that includes information of activity of patients after a hospital visit, patient care plans, or care management notes. In one instance, a patient diagnosed with diabetes may have a care plan that calls for the patient to be on a restricted diet and have daily insulin injections. The data of the patient's care plan may be sent from clinics 208 to data store module 220. CMS 206 and health information exchange 210 may send data for storage on data store module 220 and may indicate a patient's insurance eligibility, medical claim information submitted by healthcare entities, prescription information, etc. As an example, hospitals 202 may submit a claim to be reimbursed for procedures performed on patients 212. The claim may include information such as healthcare common procedure code system (HCPCS) that identify specific health interventions that were performed by medical professionals during the patient visit to hospitals 202. In some embodiments, information coordination system 204 may access the claim information stored on CMS 206 or health information exchange 210 to obtain information on visits to hospitals 202. In some embodiments, data from the healthcare entities may be transmitted to data store module 220 of information coordination system 204 over a secure (e.g., encrypted or virtual-private) network.

In some instances, data from the healthcare entities (e.g., hospitals 202 or clinics 208) may be “pulled” by information coordination system 204, where information coordination system 204 initiates the transfer of data, or “pushed” to information coordination system 204, where the healthcare entities (e.g., hospitals 202 or clinics 208) initiates the transfer of data. For example, hospitals 202 may send data that indicate that a patient has been admitted, transferred, visited, or discharged from hospital 202. In one instance, when patients 212 are admitted to the ED of a hospital, this admission is entered into a computing system of hospitals 202 and data of the admission may be sent to data store module 220 in near real-time (e.g., within an hour of the data being entered). In another instance, data may be sent from hospitals 202 to data store module 220 indicating that a patient has been discharged from hospitals 202 when the discharge paperwork of the patient is processed and entered into the computing system of hospitals 202. As another example, a doctor may summarize the diagnosis and treatment of the patient by filling out an EHR and the information of the EHR may be sent to data store module 220.

In some embodiments, patients 212 may send health data to be stored on data store module 220 and may reflect symptoms being experienced by the patient, biometrics, or health questions the patient may have. As an example, a remote home monitoring program may wirelessly connect one or more medical diagnostic devices that transcribe patients 212 medical readings in an encrypted fashion and transmit the readings to information coordination system 204 over a secure network. The diagnostic devices may include blood pressure cuffs or weight scales equipped with a suitable wireless, e.g., BLUETOOTH, technology. Furthermore, the diagnostic devices may transmit diagnosis readings to a cellular pod that then encrypts the readings and relays them to information coordination system 204.

In some embodiments, data analytics module 222 may analyze data of patients 212 stored in data store module 220 in response to receiving activity of patients 212, e.g., a patient being transferred from the ED to the intensive care ward of a hospital. For example, data analytics module 222 may determine information regarding a patient visiting a hospital has been updated in data store module 220 (e.g., through an updated time stamp). Data analytics module 222 may access information regarding the patient stored in data module 220 that pertains to long-term care plans or medications prescribed. As another example, data analytics module 222 may access information regarding the patient pertaining to medical procedures being performed at the hospital in response to data analytics module 222 determining the patient is visiting the hospital. In some embodiments, data of patients 212 may be used to generate messages or notifications of the status of patients 212. As an example, data analytics module 222 may generate messages or notifications of the status of patients 212 in response to determining data of a patient has been updated. For example, the messages may include information of the hospital treating a patient, a description of medical treatment performed on the patient at hospital, the current status of the patient, etc. accessed by data analytics module 222. The generated report may be transmitted to the assigned clinic in order to improve patient care, e.g., by setting up a follow up appointment, by reminding the patient to pick up medication, etc.

Data analytics module 222 may process historical patient data, CMS data, or clinic data to provide useful data for patient status report generation. In some embodiments, data analytics module 222 may calculate a relevance score and the generated report may include a portion of the patient data selected using the calculated relevance score. As an example, data analytics module 222 may calculate the relevance score may be based on an average length of stay for each medical condition, the amount of cost associated with treating each medical condition, the complexity of treating each medical condition, the mortality rate associated with each medical condition, the amount of follow-up care for each medical condition, etc. In some embodiments, the relevance score may be a weighted combination of the factors described above with weighting coefficients based on the patient data of patients from the same clinic 208 or hospital 202. As an example, CHF may have a high relevance score due to patients with the condition having relatively long hospital stays, relatively high mortality rates, and having to undergo complicated procedures to treat. As another example, diabetes may have a lower relevance score compared to CHF due to patients with the condition having relatively short hospital stays, relatively low mortality rates, and requiring relatively straightforward treatment.

Hospitals 202 may file claims for procedures or diagnoses of a patient that may be described using ICD codes. In some embodiments, data analytics module 222 may group the ICD codes received from CMS 206 or health information exchanges 210 into super-categories or categories that encompass several ICD codes or medical procedures. As an example, based on an ICD-9 code, data analytics module 222 may determine a patient had been treated at the ED of hospitals 202. In other embodiments, data analytics module 1122 may further calculate the relevance score based on the non-claim based or unadjudicated data of patients 212, for example near real-time activity from hospitals 202, diagnosis summaries, or ED notes from hospitals 202.

According to some embodiments, data analytics module 222 may analyze patient related data, e.g., recent hospital visit, hospital admission, hospital discharge, medication subscribed, diagnosis, etc., in order to generate alerts or reports for appropriate entities or professional to improve patient care. For example, the data analytics module 222 may trigger a report to be transmitted to a primary care physician or coordinator of clinics 208 in response to determining that the patient has been having elevated blood pressure of a period of time that was transmitted using a remote home monitoring system. As another example, data analytics module 222 may identify a patient who frequently went to the ED for asthma complications, but had not visited his primary care physician at their clinic 208 or filled a prescription for medication that could have kept their condition under control. Furthermore, data analytics module 222 may cause messaging module 224 to send a message, e.g., send a message to the patient, reminding the patient to fill the prescription for their asthma medication, send a message to the patient to set-up a follow-up visit with their primary care physician, send a message to the assigned clinic for the patient to call the patient to setup a follow up visit, etc. In some embodiments, the software suite SAS Stats that may be used to execute one or more procedures to analyze the data of patients 212 and generate the patient status report. In some embodiments, data analytics module 222 may implement data mining of the stored data using HADOOP may be used to analyze the data of hospitals 202 to compute an average length of stay for each medical condition, the amount of cost associated with treating each medical condition, the mortality rate associated with each medical condition, reimbursement rates of different type of medical procedures, etc.

In some embodiments, messaging module 226 may include one or more messaging systems or platforms which may include a database (e.g., messaging, SQL, or other database), short message service (SMS), multimedia messaging service (MMS), instant messaging services, Extensible Markup Language (XML) based messaging service (e.g., for communication with a Fusion center), JAVASCRIPT Object Notation (JSON) messaging service, place a call, send a fax, etc. As an example, a report of patients 212 with long-term care plan information and/or with relevant information to improve patient care may be sent by messaging module 226 as an e-mail message to the physicians caring for a patient having a stay at hospitals 202. As another example, messaging module may send an SMS message informing a clinical or primary care coordinator that patient 212 has been admitted to the ED of a hospital. Accordingly, appropriate actions may be taken in order to ensure the physicians, either at the hospital or clinic, treating the patient has the most complete picture of the health situation of the patient. In some embodiments, a hyperlink to the report generated by data analytics module 222 may be sent by e-mail to patients 212 through electronic mail (e-mail). In other embodiments, the report may be attached to the e-mail message.

Data representation module 224 may be operable to render a graphical user interface (GUI) displaying relevant information or a portion of the aggregated data of patients 212 based on the processed information from the data analytics module 222. Data representation module 224 may display one or more alerts or reports based on patient's history and patient's most recent activities, e.g., hospital visit, diagnosis, etc. The alerts or reports are generated in response to the patient's history and patient's most recent activities satisfying a certain condition, e.g., recent visit to a hospital, admission to ED, recent medication prescribed by a hospital, a medical reading (e.g., white blood cell count) exceeds a threshold, a medical reading (e.g., liver enzyme panels) is within a certain range, is below a certain threshold, activity of a particular type of event, etc. Data representation module 224 may thus notify a patient care professional (e.g., primary care coordinator, hospital physician, etc.) visually, audibly, etc., that a certain condition has been met by the data of a patient, e.g., elevated glucose level has been detected, patient has been admitted to the ED, etc. The healthcare professional may have the opportunity to inspect the various data that the data analytics module 222 has collected (e.g. long-term care plans, hospitalization history, medical readings, etc.) that triggered the alert.

In some embodiments, data representation module 224 may send a report that may include patient data, medical alerts, or activity of patients 212 to a messaging system (e.g., messaging system 226) for distribution (e.g., hospitals 212, clinics 208, etc.). Data representation module 224 may provide an indicator that may be output visually, audibly, or via a signal to another system (e.g., messaging module 226). In some embodiments, data representation module 224 may allow a hospital or clinic administrator to display patient's history and patient's most recent activities, e.g., hospital visit, diagnosis, etc. The healthcare professional may have the opportunity to inspect the various data that the data analytics module 222 has collected (e.g. long-term care plans, hospitalization history, medical readings, etc.) that triggered the alert or report.

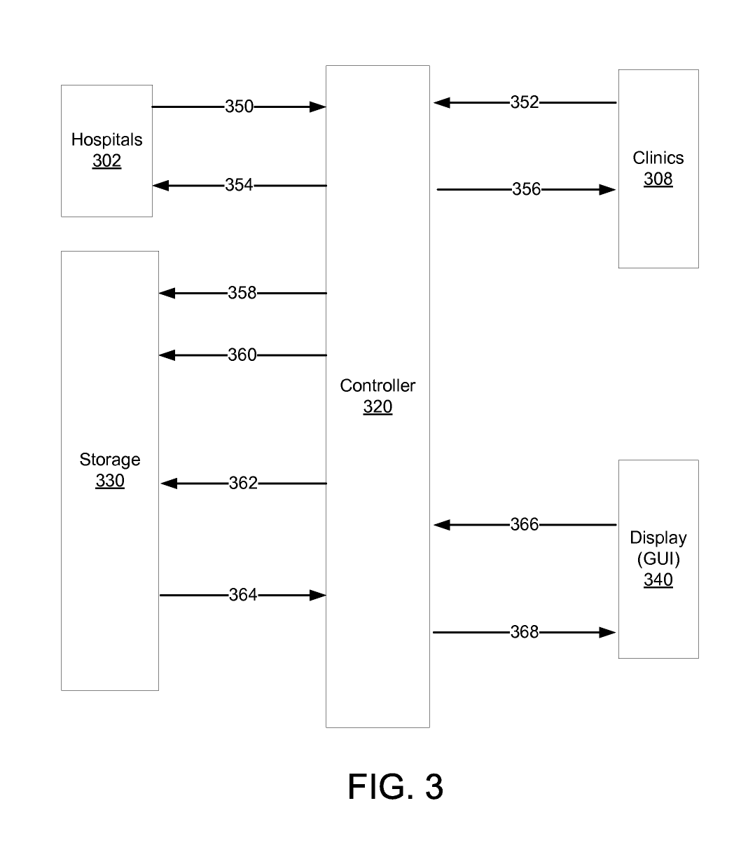

FIG. 3 illustrates data interactions within an information coordination system according to some embodiments. “Longitudal data” may be separately stored by a number of healthcare entities, transmitted to the information coordination system, and aggregated in a storage 330. The information coordination system may access the data stored on storage 330 mine the data to provide a patient status report to the hospital administrator. As an example, a patient assigned to a clinic 308 may be recently recovering from an infection that was treated with antibiotics. This patient may visit hospital 302 complaining of chest pains. Hospital 302 may register the patient and this information may be send to controller 320 of the information coordination system. Controller 320 may identify the patient and access the medical data of the patient stored on storage 330. Controller 320 sends the information about the infection to hospital 302 so that the physicians caring for the patient are aware of the previous infection. Also controller 320 sends information that the patient is visiting hospital 320 complaining of chest pain. The physicians caring for the patient at hospitals 320 may want to see the patient history before deciding on a course of treatment and pull up the patient data stored on storage 330. The patient data may be displayed on a GUI for the physician to view.

In some embodiments, a controller 320 of the information coordination system may receive data from hospitals 302 and clinics 308. Data (e.g., longitudinal) of patients 112 generated by hospitals 302 and clinics 308 may be stored on storage 330, e.g., in a particular data structure, database format, hierarchical format, etc. For example, a hierarchical format may sort data by patient name first and everything else at the bottom, or hospital first and the rest below it, or clinic first and everything else below it, etc. As an example, storage 330 may include data store module 220. In some embodiments, controller 320 may automatically and directly access longitudinal patient data locally stored in storage devices (not shown) of hospitals 302 and clinics 308 through a web-based portal.

In some embodiments, controller 320 may receive near real-time activity of patients 112, DX summaries, or ED notes from hospitals 302. As described above, hospitals 302 may send data 350 that indicates that a patient has been admitted, transferred, visited, or discharged from hospital 302. In one instance, when a patent is discharged from a hospital, this admission and discharge is entered into a computing system of hospitals 302 and data 350 of the admission may be received by controller 320 in “real-time”. In another instance, a doctor treating a patient at hospitals 302 may summarize the diagnosis and treatment of the patient by filling out an EHR and the information of the EHR 350 may be received by controller 320.

In some embodiments, controller 320 may receive information 352 of activity of patients after a hospital visit, patient care plans, or care management notes from clinics 308. In one instance, controller 320 may receive information 352 that a patient who has asthma has been prescribed an albuterol inhaler. In another instance, controller 320 may receive information 352 that the patient has been participating in follow-up visits with a physician at clinics 308 for their asthma condition and the data detailing the current treatment of the asthma condition. However, it is appreciated that according to some embodiments patient's participation is optional and that clinics 308 may be notified regardless of patient's permission to participate, provided that the hospitals 302 and/or clinics 308 are eligible to provide service.

In some embodiments, storage 330 may store data from CMS, health information exchanges, patients, etc. As an example, storage 330 may store lab data (e.g., lipid, glucose, etc.), prescription (e.g., medication), or secure messaging information of patients from health information exchanges. For instance, a pharmacy may submit a claim to CMS after filling an albuterol inhaler prescription for a patient and that data may be stored in storage 330. In another instance, hospitals 302 may file claims for procedures or diagnoses of a patient that may be described using the international classification of diseases (ICD) codes, e.g., where a common revision of the ICD codes is revision 9 (ICD-9 codes). In some embodiments, controller 320 may categorize the ICD-9 codes received from CMS or health information exchanges into categories of treatment. As an example, based on an ICD-9 code, controller 320 may determine a patient had been treated at the ED of hospitals 302 and this information may be stored in storage 330. Patients may provide data of symptoms, biometrics, health questions, etc. In some embodiments, controller 320 may receive data from patients through a home monitoring system, as described above. In other embodiments, storage 330 may store the non-claim based or unadjudicated data 358 of patients, for example near real-time activity from hospitals 302, DX summaries, or ED notes from hospitals 302. In other embodiments, storage 330 may store the activity 360 of patients after a hospital visit, patient care plans, or care management notes from clinics 308.

In some embodiments, controller 320 may analyze a combination of near real-time data and historical data of patients (e.g., from hospitals 302 or CMS) in order to generate a report or initiate an action. As an example, controller 320 may analyze the long-term care plans of a patient to determine chronic medical issues the patient may be experiencing and current treatment from clinics 308 and information from filled prescriptions from the CMS, along with the real-time information provided by hospital 302. Based on the relevance score described above, controller 320 may generate a report that includes patient data in response to the patient visiting a hospital. Controller 320 may provide relevant data 354 (e.g., long-term care plan or medications) of patients to hospitals or provide data 356 to clinics in response to near real-time data 350 of activity of the patient. In some embodiments, controller 320 may select the relevant patient data based on the relevance score described above. In one instance, a hospital where the patient is visiting for an asthma episode may receive information that the patient has never filled a prescription for their albuterol inhaler and did not have a follow-up visit with their primary care physician (PCP) of clinics 308. Accordingly, instead of readmitting the patient, the patient may be referred to his assigned clinic for a follow up visit and the medication for asthma may be filled at the hospital. Furthermore, clinics 308 may receive a near real-time alert that the patient has visited the ED of hospitals 302 and another real-time alert when the patient is discharged from the hospital with a recommendation to follow up with the assigned clinic. A primary care coordinator of clinics 308 may then reach out to the patient to schedule a follow-up appointment with the patient's PCP.

As another example, controller 320 may provide information 354 to hospitals 302 that a patient is on a regimen of nitroglycerin tablets for chronic heart failure (CHF), prescribed by clinics 308, in response to controller 320 receiving information 350 that the patient has visited the ED of a hospital. In addition, controller 320 may access other patient data from storage 330, for example electrocardiograph (ECG) readings from Holter monitor coupled to a home monitoring system through a wired connection, and provide the ECG readings to hospitals 302. As an example, the hospital treating the patient may use the record of previous ECG readings to refine the diagnosis and treatment of the patient visiting the ED complaining of chest pains.

Furthermore, clinics 308 may receive a real-time alert when the patient is discharged from the hospital and the primary care coordinator of clinics 308 may then reach out to the patient to schedule a follow-up appointment with the patient's PCP. In other embodiments, controller 320 may analyze ICD-9 codes 350 received directly from hospitals 302 (e.g., unadjudicated claims or “claims in flight”) and perform an action based on the unadjudicated claims prior to being reviewed by CMS 306. As an example, the information coordination system may send a report to clinics 308 suggesting that the patient care coordinator at clinics 208 to follow-up on one or more treatments identified by the ICD-9 codes accessed from hospitals 308.

In some embodiments, the controller 320 associated with the information coordination system may cause a display 340 to render a GUI. The rendered information on the GUI may be used for monitoring the health status and providing near real-time access of data of patients. Interaction with the GUI 366 may allow for review of current medical data of the patient, historical medical data of the patient, and clinic information of the patient and stored in storage. As an example, a listing of the medical activity of patients may be displayed 368. As another example, appropriate personnel may view of an image or video footage (e.g., motion or still images) corresponding to medical data of the patient (e.g., ultrasound data, magnetic resonant imaging (MRI), computed tomography (CT) scans, etc.) 368. For example, patient's last hospital visit, patient's last clinic visit, patient's reason for hospital visit, diagnosis, prescription, discharge date, the number of times patient has been admitted to the hospital, whether it was the same hospital or different hospitals.

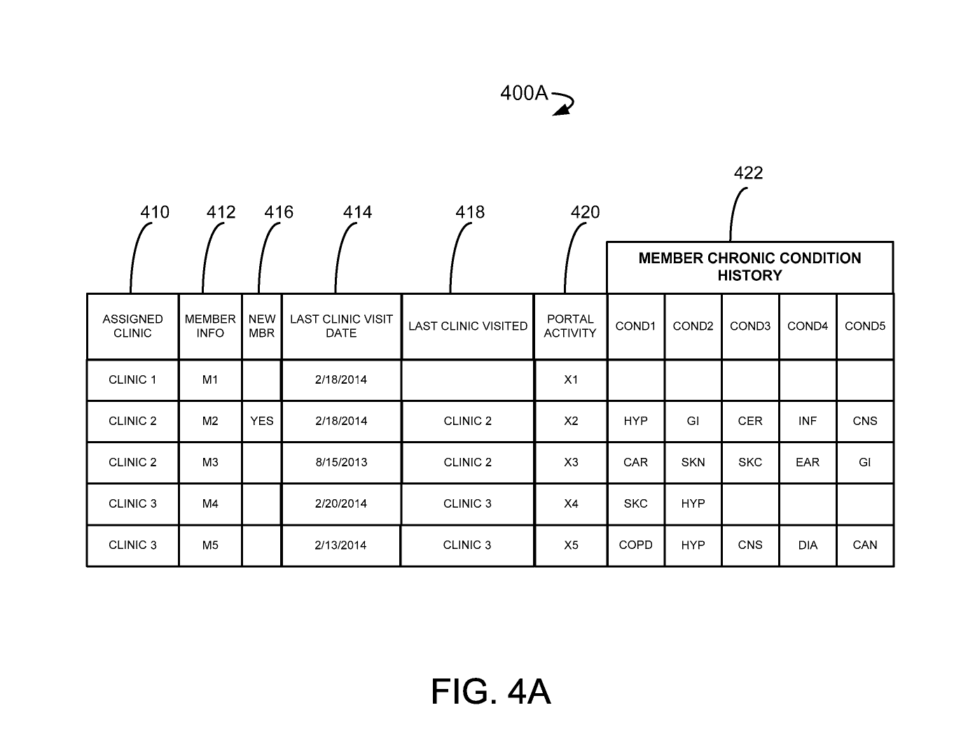

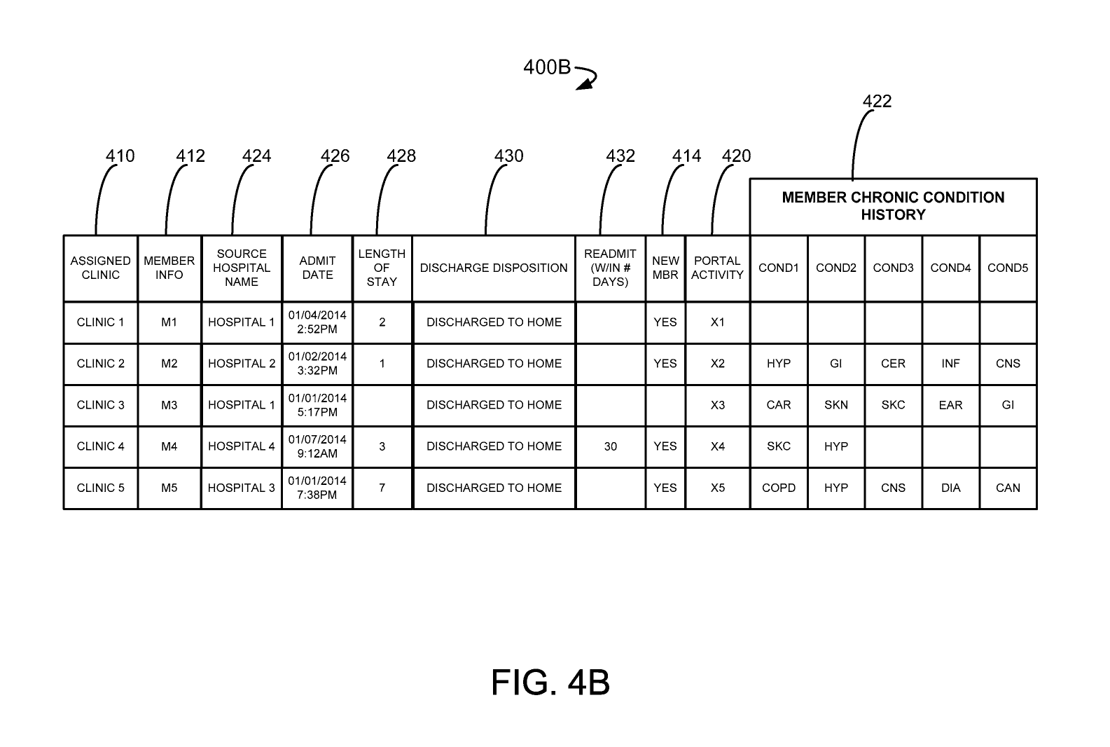

FIGS. 4A-4B illustrate a report on a graphical user interface according to some embodiments. Although this disclosure illustrates and describes display of a report on a GUI, this disclosure contemplates the report taking any suitable form, for example a paper copy, a downloaded file, hyperlink, etc. Such forms are contemplated throughout the disclosure. Furthermore, the disclosure illustrates and describes GUIs having a configuration of graphical elements or icons, this disclosure contemplates any suitable GUI having any suitable configuration of graphical elements or icons. In some embodiments, the report is the output that is generated by the information coordination system.

As described above, information coordination system 204 may provide a graphical user interface (GUI) 400A and 400B to monitor the current status of patients 112. In some embodiments, GUI 400A and 400B may provide information of patients 112. For example, GUI 400A may include an assigned clinic 410 field, member information 412 field, new member 414 field, last clinic visit date 416 field, last clinic visited 418 field, portal activity 420, and member chronic condition history 422 field. It is appreciated that selection of each field may provide additional information regarding the field, e.g., selection of a particular chronic condition may provide additional information about the condition, etc. As an example, the information belonging to a selected field may be expanded or collapsed through actuation of an icon (e.g., expand or collapse icon) displayed on GUI 400A-B. According to some embodiments, selection of a field may expand the field to provide additional information or may result in a pop-up window providing the additional information, etc. In some embodiments, one or more fields of display area 400A-400B may be selected to provide additional detailed information of the data in the field (e.g., as a hyperlink). For example, selecting the name of a patient may initiate display (e.g., as a pop-up display or another webpage) the data (e.g., age, sex, medical history, medical conditions, etc.) of the patient.

GUI 400A may include an assigned clinic field 410, member information 412, new member 414 field, last clinic visit date 416, last clinic visited 418, portal activity 420, and member chronic condition history 422. The assigned clinic 410 field may indicate the clinic that the member is assigned and associated with. Member information 412 field may include information regarding the member, e.g., member identification, member name, member date of birth, member telephone number, member address, etc.

The new member 414 may indicate whether the member is a new member or not. For example, if a member is a new member, a computing device may trigger an alert for the clinic to designate additional time for the new member in order to do a more thorough work up. The generated trigger may be an alert, e.g., an email, phone call, fax, etc., sent via a device, e.g., smart phone, computing device, pager, telephone, email exchange server, etc., to the appropriate personnel in the assigned clinic to the new member.

Last clinic visit date 416 may indicate the date of which the member last visited a clinic. Last visited clinic 418 may indicate the name of the clinic that was visited last. The last visited clinic assigned field 418 may indicate whether the member's last visit to the clinic was to the member's assigned clinic. Accordingly, if the member's last visit has been to a non-assigned clinic, a trigger may be generated by an electronic device such as the information coordination system (described above) to notify the clinic in advance to designate additional time to update the member's chart and information. The trigger may be an email, a phone call, a fax, a report, etc., that gets transmitted via a smart phone, computing device, a pager, a telephone, an exchange server, etc., to the appropriate personnel at the clinic.

The last portal activity field 420 may provide information regarding portal activities, e.g., last portal activity date, last portal activity type such as scheduled appointment, member information updated, etc. The member chronic condition history 422 may indicate one or more chronic conditions (e.g., CHF, asthma, chronic obstructive pulmonary disease (COPD), diabetes, high-blood pressure, etc.) for which each patient may be undergoing treatment. It is appreciated that the number of chronic condition fields may be user selectable and may be varied. For example, in some embodiments, the top seven chronic conditions may be displayed. In other embodiment, in response to a user selection, additional chronic condition may be displayed. In other words, in response to a user selection additional information associated with a patient may be displayed whether that information is related to the chronic history or any other patient attribute. The information of chronic conditions may further include an indicator (e.g., color or status) of the severity of the chronic condition. It is appreciated that the computing system analyzing the member's information and data associated therewith may prioritize and sorted based on heuristics to select the top five chronic conditions, e.g., based on severity of the condition. It is, however, appreciated that the conditions may be sorted based on any criteria and is not necessarily limited to the severity of the conditions.

Referring now to FIG. 4B, another report according to some embodiments is shown. It is appreciated that the same element numbers as that of FIG. 4A are the same fields and have been described above. GUI 400B is a discharge report used by hospitals. The GUI 400B includes a source hospital name 424 field, admission date 426 field, length of stay 428 field, discharge disposition 430 field, and readmission within a certain number of days 432 field. The source hospital name 424 field may indicate the name of the hospital that the member visited.

The admission date 426 may indicate the date and time that the member visited the hospital. The length of stay 428 field may indicate the number of days that the member was hospitalized. The discharge disposition 430 may provide information regarding the member's discharge. For example, the member may be discharged home, to another hospital, to hospice care, etc. Readmission within a certain number of days 432 field may indicate the number of times that the member was readmitted within a certain period of time, e.g., 30 days, 60 days, etc. It is appreciated that the members may be sorted based on their chronic condition history, based on readmission number, based on length of stay, etc. In other words, the sorting of members and their presentation may be based on any user selectable criteria or it may be based on some heuristics.

Accordingly, a trigger, e.g., an email, a pager, an automatic phone call, automatic fax, automatic appointment setup, etc., may be generated by an electronic device, e.g., information coordination system, to alert appropriate personnel of complex members with a higher risk of being readmitted. For example, the appropriate personnel may be notified to setup an appointment for members with a higher risk of being readmitted. As such, the follow up appointment may in fact lower the risk of readmission because patient care is improved by going to a clinic instead. In another example, the trigger may notify the appropriate personnel to reach out to the member to answer questions, reinforce disease-specific education and to confirm that the members are receiving follow up care with their designated primary care physicians. In other embodiments, the trigger may enable the appropriate personnel to assess and reach out to members with additional transition needs of care education, medication compliance, home health care services, etc.

It is appreciated that the fields illustrated (for any of the reports presented) are for illustrative purposes only and should not be construed as limiting the scope of the embodiments. For example, the report may include additional fields, e.g., last prescription filled within a certain number of days, the date of last prescription refill, admission reason, hospital service rendered (e.g., ICU, ER, surgery, radiology, etc.), primary diagnosis description, etc.

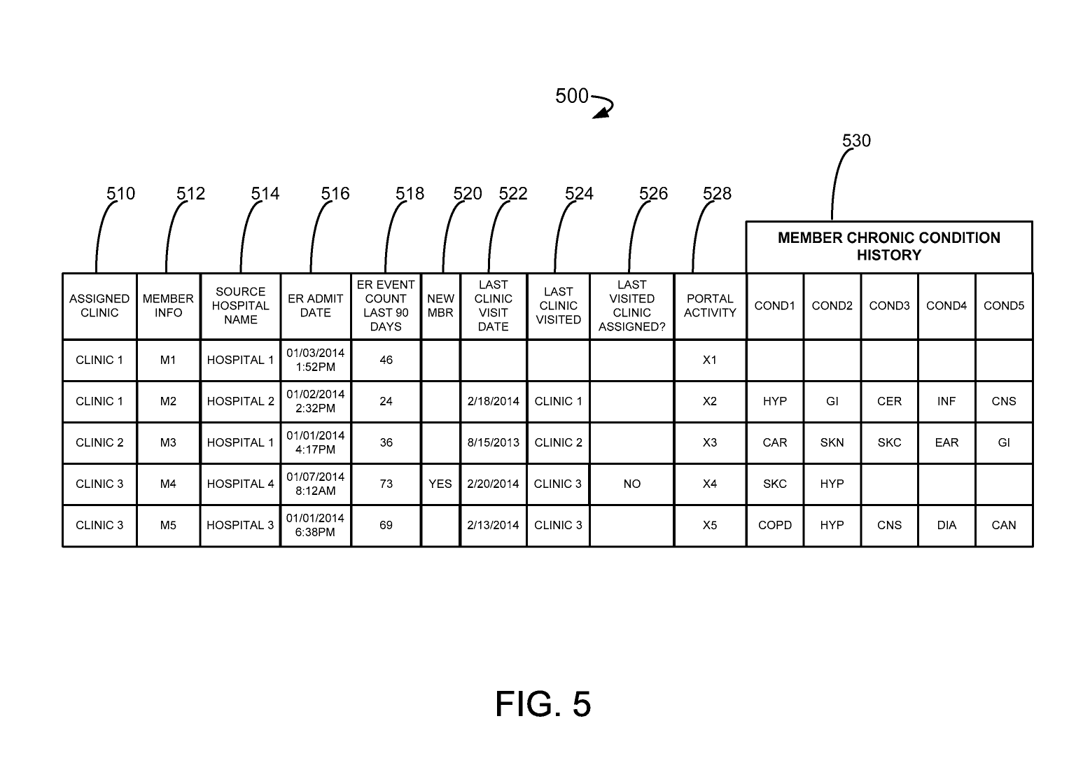

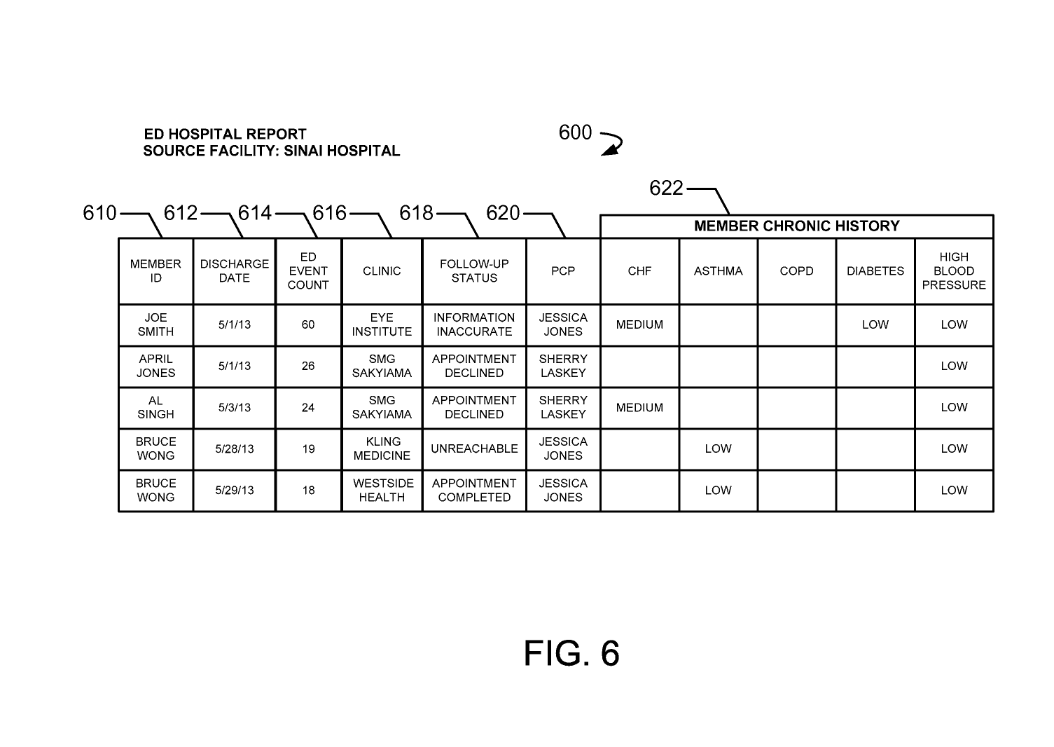

FIGS. 5-6 illustrate alert reports displayed on a graphical user interface according to some embodiments. In some embodiments, alert report 500 may alert the assigned clinic of the member that the member has visited the hospital. As illustrated in FIG. 5, report 500 may include an assigned clinic field 510, member information 512 field, source hospital name 514, ER admission date 516, number of ER counts in the last 90 days 518, new member 520 field, last clinic visit date 522, last clinic visited 524, last clinic visited assigned 526, portal activity 528, and member chronic condition history 530. The assigned clinic 510 field may indicate the clinic that the member is assigned and associated with. Member information 512 field may include information regarding the member, e.g., member identification, member name, member date of birth, member telephone number, member address, etc. The source hospital name 514 may indicate the name of the hospital that the member visited.

The ER admission date 516 may indicate the date and time that the member visited the hospital. Number of ER counts in the last 90 days 518 may indicate the number of times that the member has visited the ER. It is appreciated that the period of 90 days is illustrative and should not be construed as limiting the embodiments. New member 520 may indicate whether the member is a new member or not. For example, a new member may not have an assigned clinic, triggering an alert, e.g., an email, phone call, fax, etc., to be sent via a device, e.g., smart phone, computing device, pager, telephone, email exchange server, etc., to the appropriate personnel to assign a clinic to the new member.

Last clinic visit date 522 may indicate the date of which the member last visited a clinic (either assigned or not). Last visited clinic 524 may indicate the name of the clinic that was visited last. The last visited clinic assigned field 526 may indicate whether the member's last visit to the clinic was to the member's assigned clinic.

The last portal activity field 528 may provide information regarding portal activities, e.g., last portal activity date, last portal activity type such as scheduled appointment, member information updated, etc. The member chronic condition history 530 may indicate one or more chronic conditions (e.g., CHF, asthma, chronic obstructive pulmonary disease (COPD), diabetes, high-blood pressure, etc.) for which each patient may be undergoing treatment. It is appreciated that the number of chronic condition fields may be user selectable and may be varied. For example, in some embodiments, the top seven chronic conditions may be displayed. In other embodiment, in response to a user selection, additional chronic condition may be displayed. In other words, in response to a user selection additional information associated with a patient may be displayed whether that information is related to the chronic history or any other patient attribute. The information of chronic conditions may further include an indicator (e.g., color or status) of the severity of the chronic condition. It is appreciated that the computing system analyzing the member's information and data associated therewith may prioritize and sorted based on heuristics to select the top five chronic conditions, e.g., based on severity of the condition. It is, however, appreciated that the conditions may be sorted based on any criteria and is not necessarily limited to the severity of the conditions.

Accordingly, a trigger, e.g., an email, a pager, an automatic phone call, automatic fax, automatic appointment setup, etc., may be generated by an electronic device, e.g., information coordination system, to alert appropriate personnel of complex members with a higher risk of being readmitted. For example, the appropriate personnel may be notified to setup an appointment for members, gauge appointment slot priority by assessing health severity of members, etc. In another example, the trigger may notify the appropriate personnel to use admission time to assess member's behavior, e.g., whether or not a member could have visited a clinic during business hours instead of utilizing ER services during the day, etc. As such, appropriate steps may be taken to lower cost and improve patient care. In some embodiments, the trigger may notify the appropriate personnel to reach out to new members and identify those that may wish want to schedule an annual appointment, e.g., annual physical, etc., instead of just an ER follow up.

Referring now to FIG. 6, another report according to some embodiments is shown. In some embodiments, alert report 600 may alert clinics that one of their assigned patients has recently been discharged from the ED of hospitals. As illustrated in FIG. 6, report 600 may include an member identification (ID) field 610, discharge date 612 field, ED event count 614 field, clinic 616 field, follow-up status 618 field, primary care physician (PCP) 620 field, and member chronic condition history 622. Member identification 610 field may include information regarding the member, e.g., member identification number, member name, member date of birth, member telephone number, member address, etc.

The discharge date 612 may indicate the date and time that the member was discharged from the ED of a hospital. Number of ED counts 614 may indicate the number of times that the member has visited the ED of a hospital. It is appreciated that ED count 614 may occur over a period of time (e.g., 90 days). The ED count 614 may provide a metric to determine the effectiveness of healthcare treatment for each patient or flag one or more patients that may require more extensive follow-up treatment. As an example, a patient with a relatively high ED event count 614 may require the patient care coordinator of the assigned clinic to more closely monitor the aftercare treatment of the patient. For instance, patients may receive more frequent phone calls or SMS messages reminding them about follow-up visits with their PCP. In some embodiments, a patient may be flagged based on a given threshold number of ED visits. As an example, the threshold number of ED visits may be manually set by a primary care coordinator of a clinic. As another example, the threshold number of ED visits may be set by the data analytics module based on data of patients indicating on average a given ED count 614 may be an indication of increased readmission to the ED. It is appreciated that the patients may then be prioritized and hierarchically ordered based on the ED count 614, for instance.

Clinic 616 field may indicate the clinic that the member is assigned and associated with. Follow-up status 618 may indicate whether the member has performed one or more follow-up procedures. For example, a member may have completed a follow-up visit with their PCP, is unreachable, may have inaccurate patient information on file, declined a scheduled follow-up appointment with their PCP, etc. The follow-up status 618 may trigger an alert, e.g., an email, phone call, fax, etc., to be sent via a device, e.g., smart phone, computing device, pager, telephone, email exchange server, etc., to the appropriate personnel to flag a member for additional follow-up. PCP 620 field may indicate the primary care physician that a member is assigned and associated with.

As described above, member chronic condition history 622 may indicate one or more chronic conditions (e.g., CHF, asthma, COPD, diabetes, high-blood pressure, etc.) for which each patient may be undergoing treatment. It is appreciated that the number of chronic condition fields may be user selectable and may be varied. For example, in some embodiments, the top seven chronic conditions may be displayed. In other embodiment, in response to a user selection, additional chronic condition may be displayed. In other words, in response to a user selection additional information associated with a patient may be displayed whether that information is related to the chronic history or any other patient attribute. The information of chronic conditions may further include an indicator (e.g., color or status) of the severity of the chronic condition. It is appreciated that the computing system analyzing the member's information and data associated therewith may prioritize and sorted based on heuristics to select the top five chronic conditions, e.g., based on severity of the condition. It is, however, appreciated that the conditions may be sorted based on any criteria and is not necessarily limited to the severity of the conditions. In some embodiments, the ordering may be based on the relevance score described above, where patient data associated with conditions with a higher relevance score (e.g., diabetes) may be displayed before patient data associated with conditions having a lower relevance score (e.g., asthma). However, it is appreciated that the patients may be prioritized or hierarchically ordered in the report based on any criteria, which may be user modifiable.

It is appreciated that the fields illustrated in reports discussed herein are for illustrative purposes only and should not be construed as limiting the embodiments. For example, the reports (as described in FIGS. 5-6) may include additional fields, e.g., prescription fill status indicating whether the prescription has been filled. Moreover, the reports may include fields associated with lab works, e.g., magnetic resonance imaging, computerize tompography, X-rays, blood works, etc.

With respect to any of the reports described herein, it is appreciated that selection of each field may provide additional information regarding the field, e.g., selection of a particular chronic condition may provide additional information about the condition, etc. As an example, the information belonging to a selected field may be expanded or collapsed through actuation of an icon (e.g., expand or collapse icon) displayed on GUI. According to some embodiments, selection of a field may expand the field to provide additional information or may result in a pop-up window providing the additional information, etc. In some embodiments, one or more fields of display area may be selected to provide additional detailed information of the data in the field (e.g., as a hyperlink). For example, selecting the name of a patient may initiate display (e.g., as a pop-up display or another webpage) the data (e.g., age, sex, medical history, medical conditions, etc.) of the patient.

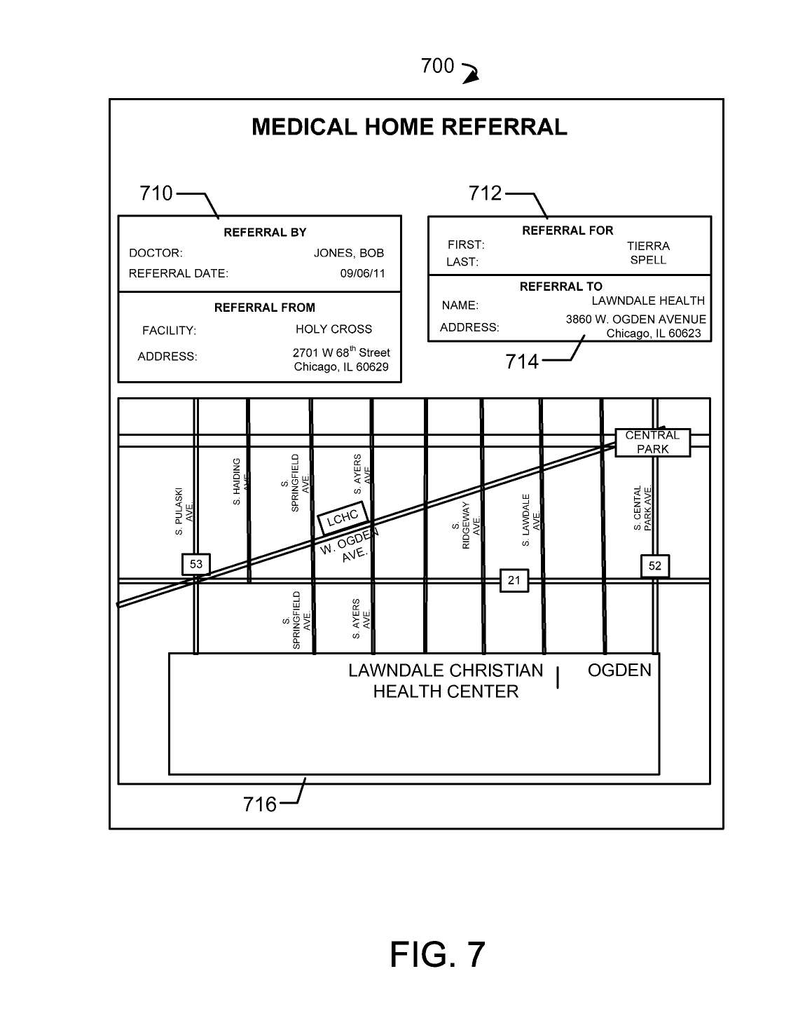

FIG. 7 illustrates a clinic referral according to some embodiments. In some embodiments, clinic referral form 700 is the output that is generated by the information coordination system. Referral form 700 may include information of referring entity 710, member information 712, clinic information 714, and clinic location information 716. Referring entity information 710 may include information regarding the referring entity, e.g., referring physician name, referral date, name of the referring entity, the address of the referring entity, etc. Member information 712 may include information regarding the member, e.g., first name, last name, etc. Clinic information 714 may include information regarding the clinic assigned to a member, e.g., name of the clinic, address of the clinic, etc. Clinic location information 716 may include information regarding the location of the clinic, e.g., operating hours of the clinic, a map detailing public transportation options, an image of the façade of the clinic, etc.

As an example, the information coordination system may generate and transmit clinic referral form in response to determining a patient has been discharged from a hospital. Patients may receive a clinic referral 700 to a clinic once they are discharged from a hospital. In some embodiments, clinic referral 700 may be sent to patients through the messaging module such as an e-mail message attachment or hyperlink to a GUI. As an example, clinic referral may include a map indicating the location of the assigned clinic, contact information, information indicating public transportation options, an image of the clinic, etc. In other embodiments, clinic referral form 700 is sent to the clinic of the patient and the clinic may contact the patient to enroll the patient with the clinic.

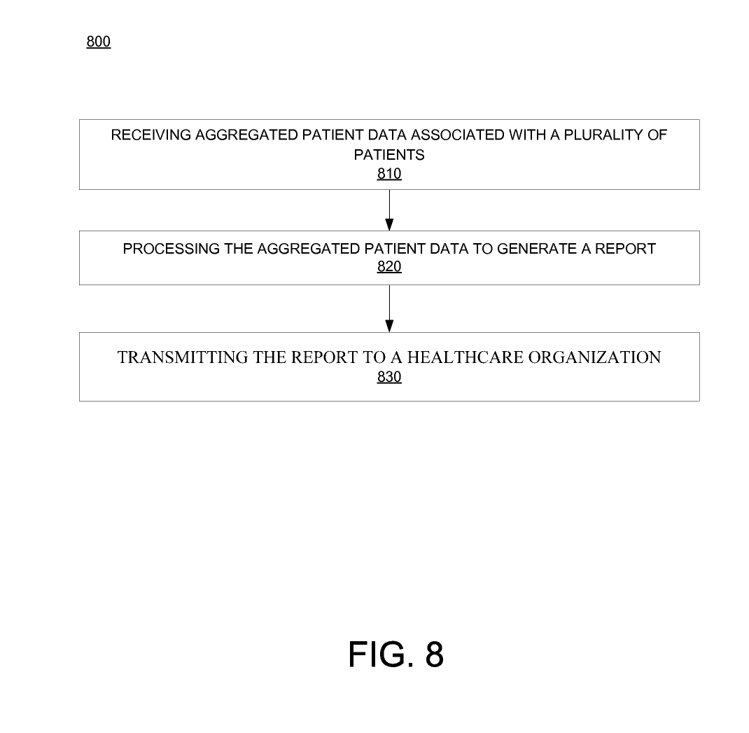

FIG. 8 illustrates a flow chart diagram 800 for generating reports according to some embodiments. At step 810, aggregated patient data associated with a plurality of patients is received from a memory storage. In some embodiments, the aggregated patient data for each patient of the plurality patients includes historical data associated with a respective patient and recent patient activity associated with the respective patient. As an example, the recent patient activities are from a number of healthcare organizations and are non-claim based. At step 820, the aggregated patient data is processed to generate a report including recent patient activities that are actionable by the healthcare organizations. As described above, the report may be an alert report as described in FIGS. 5-6. At step 830, the report is transmitted to one or more of the healthcare organizations.

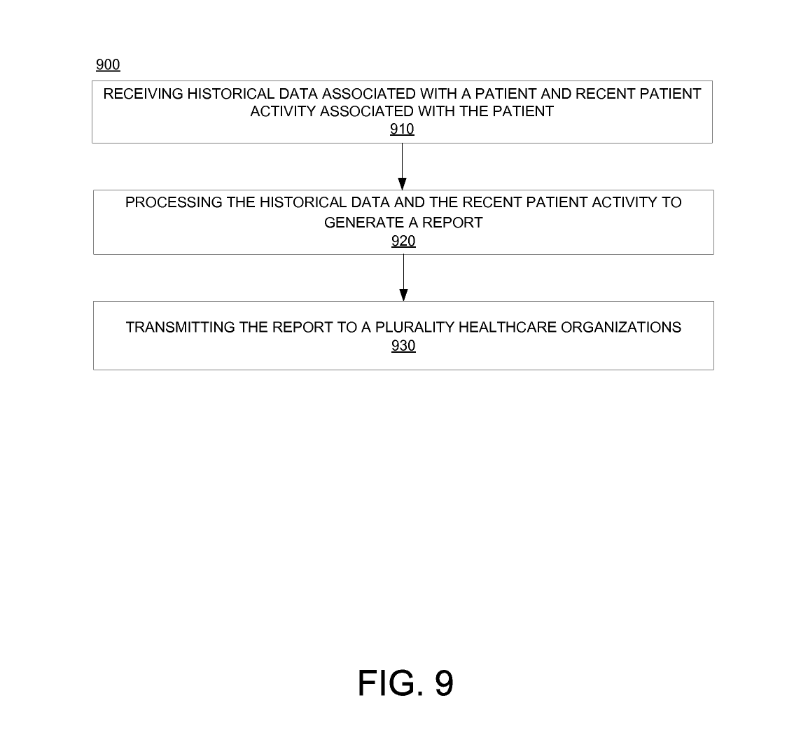

FIG. 9 illustrates another flow chart diagram 900 for aggregating data from disparate healthcare entities according to some embodiments. At step 910, data from a first healthcare entity corresponding to a status of the patient is received. In some embodiments, the status of the patient corresponds to admission to the ED, a transfer within a hospital, or a discharge from the hospital. At step 920, data from a second healthcare entity is accessed in response to receiving the data from the first healthcare entity. For example, information coordination system may access information corresponding to medication treatment, medical plan, or medical history of the patient being performed through a clinic. Furthermore, information coordination system 204 may access the data through a database stored in a data store module. At step 930, the accessed data are transmitted to the first healthcare entity. In some embodiments, the data may be rendered on a GUI or provided as an e-mail message to the hospital treating the patient.

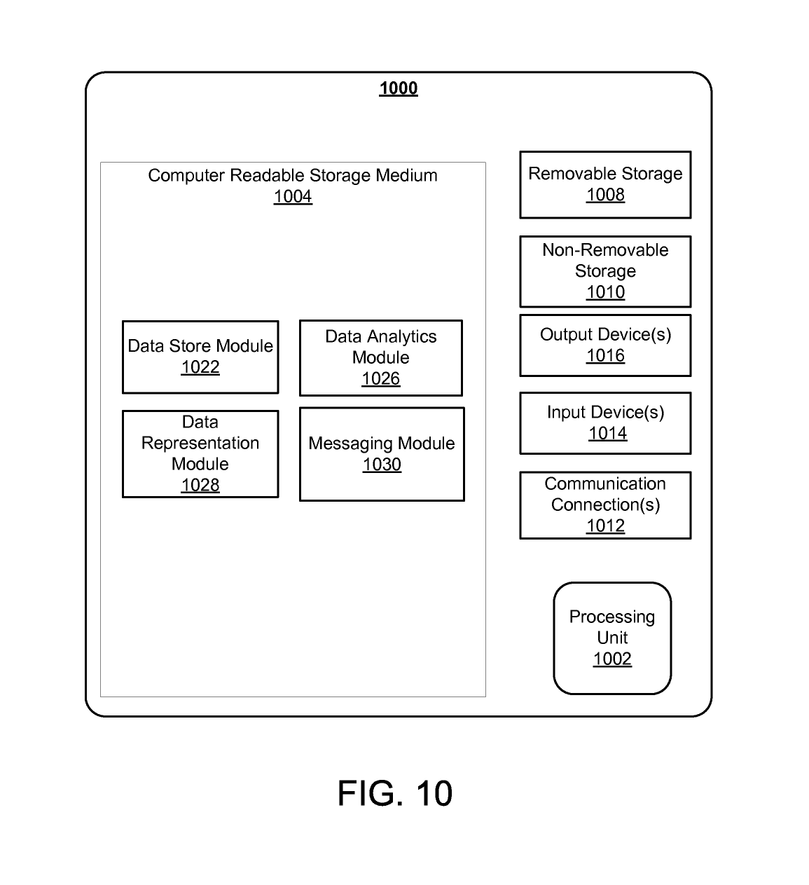

FIG. 10 illustrates a computer system according to some embodiments. As illustrated in FIG. 10, a system module for implementing embodiments includes a general purpose computing system environment, such as computing system environment 1000. Computing system environment 1000 may include, but is not limited to, servers, switches, routers, desktop computers, laptops, tablets, mobile devices, and smartphones. In its most basic configuration, computing system environment 1000 typically includes at least one processing unit 1002 and computer readable storage medium 1004. Depending on the exact configuration and type of computing system environment, computer readable storage medium 1004 may be volatile (such as RAM), non-volatile (such as ROM, flash memory, etc.) or some combination of the two. Portions of computer readable storage medium 1004 when executed generate a patient status report (e.g., processes 800 and 900).

Additionally, in various embodiments, computing system environment 1000 may also have other features/functionality. For example, computing system environment 1000 may also include additional storage (removable and/or non-removable) including, but not limited to, magnetic or optical disks or tape. Such additional storage is illustrated by removable storage 1008 and non-removable storage 1010. Computer storage media includes volatile and nonvolatile, removable and non-removable media implemented in any method or technology for storage of information such as computer readable instructions, data structures, program modules or other data. Computer readable medium 1004, removable storage 1008 and nonremovable storage 1010 are all examples of computer storage media. Computer storage media includes, but is not limited to, RAM, ROM, EEPROM, flash memory or other memory technology, expandable memory (e.g., USB sticks, compact flash cards, SD cards), CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 1000. Any such computer storage media may be part of computing system environment 1000.

In some embodiments, computing system environment 1000 may also contain communications connection(s) 1012 that allow it to communicate with other devices. Communications connection(s) 1012 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Communications connection(s) 1012 may allow computing system environment 1000 to communicate over various networks types including, but not limited to, fibre channel, small computer system interface (SCSI), Bluetooth, Ethernet, Near Field Chip (NFC), Wi-fi, Infrared Data Association (IrDA), Local area networks (LAN), Wireless Local area networks (WLAN), wide area networks (WAN) such as the internet, serial, and universal serial bus (USB). It is appreciated the various network types that communication connection(s) 1012 connect to may run a plurality of network protocols including, but not limited to, transmission control protocol (TCP), user datagram protocol (UDP), internet protocol (IP), real-time transport protocol (RTP), real-time transport control protocol (RTCP), file transfer protocol (FTP), and hypertext transfer protocol (HTTP).

In further embodiments, computing system environment 1000 may also have input device(s) 1014 such as keyboard, mouse, a terminal or terminal emulator (either connected or remotely accessible via telnet, SSH, http, SSL, etc.), pen, voice input device, touch input device, remote control, etc. Output device(s) 1016 such as a display, a terminal or terminal emulator (either connected or remotely accessible via telnet, SSH, http, SSL, etc.), speakers, light emitting diodes (LEDs), etc. may also be included. All these devices are well known in the art and are not discussed at length.

In one embodiment, computer readable storage medium 1004 includes a data store module 1022, data analytics module 1026, data representation module 1028, and a messaging module 1030. The data store 1022 may be similar to data store module 220 described above and is operable to store data associated with patients according to flow diagrams 800 and 900, for instance. Data analytics module 1026 may be similar to data analytics module 222 described above and may be used to process historical data and recent patient activity, as discussed with respect to flows 800 and 900. Data representation module 1028 may be similar to the data representation module described above and may be configured to present data of the patient. Messaging module 1030 may be similar to the messaging module described above and may be configured to transmit a report that includes historical data of the patient.

It is appreciated that implementations according to embodiments of the present invention that are described with respect to a computer system are merely exemplary and not intended to limit the scope of the present invention. For example, embodiments of the present invention may be implemented on devices such as switches and routers, which may contain application specific integrated circuits (ASICs), field programmable gate arrays (FPGAs), etc. It is appreciated that these devices may include a computer readable medium for storing instructions for implementing methods according to flow diagrams 800 and 900.

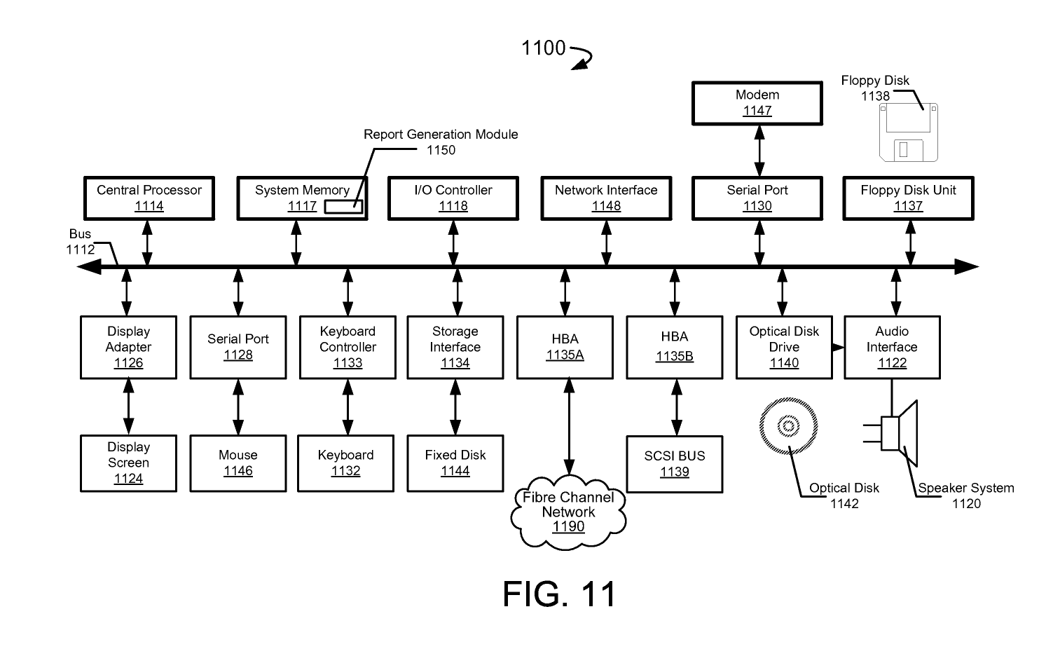

FIG. 11 illustrates a block diagram of another computer system according to some embodiments. FIG. 11 depicts a block diagram of a computer system 1100 suitable for implementing the present disclosure. Computer system 1100 includes a bus 1112 which interconnects major subsystems of computer system 1100, such as a central processor 1114, a system memory 1117 (typically RAM, but which may also include ROM, flash RAM, or the like), an input/output controller 1118, an external audio device, such as a speaker system 1120 via an audio output interface 1122, an external device, such as a display screen 1124 via display adapter 1126, serial ports 1128 and 1130, a keyboard 1132 (interfaced with a keyboard controller 1133), a storage interface 1134, a floppy disk drive 1137 operative to receive a floppy disk 1138, a host bus adapter (HBA) interface card 1135A operative to connect with a Fibre Channel network 1190, a host bus adapter (HBA) interface card 1135B operative to connect to a SCSI bus 1139, and an optical disk drive 1140 operative to receive an optical disk 1142. Also included are a mouse 1146 (or other point-and-click device, coupled to bus 1112 via serial port 1128), a modem 1147 (coupled to bus 1112 via serial port 1130), and a network interface 1148 (coupled directly to bus 1112). It is appreciated that the network interface 1148 may include one or more Ethernet ports, wireless local area network (WLAN) interfaces, etc., but is not limited thereto. System memory 1117 includes a report generation module 1150 which is operable to generate a report that includes recent activities of the patient. According to one embodiment, the report generation module 1150 may include other modules for carrying out various tasks. For example, report generation module 1150 may include data store module 1022, data analytics module 1026, data representation module 1028, and messaging module 1030, as discussed with respect to FIG. 10 above. It is appreciated that the report generation module 1150 may be located anywhere in the system and is not limited to the system memory 1117. As such, residing of the report generation module 1150 within the system memory 1117 is merely exemplary and not intended to limit the scope of the present invention. For example, parts of the report generation module 1150 may reside within the central processor 1114 and/or the network interface 1148 but are not limited thereto.

Bus 1112 allows data communication between central processor 1114 and system memory 1117, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with computer system 1100 are generally stored on and accessed via a computer readable medium, such as a hard disk drive (e.g., fixed disk 1144), an optical drive (e.g., optical drive 1140), a floppy disk unit 1137, or other storage medium. Additionally, applications can be in the form of electronic signals modulated in accordance with the application and data communication technology when accessed via network modem 1147 or interface 1148.

Storage interface 1134, as with the other storage interfaces of computer system 1100, can connect to a standard computer readable medium for storage and/or retrieval of information, such as a fixed disk drive 1144. Fixed disk drive 1144 may be a part of computer system 1100 or may be separate and accessed through other interface systems. Network interface 1148 may provide multiple connections to other devices. Furthermore, modem 1147 may provide a direct connection to a remote server via a telephone link or to the Internet via an internet service provider (ISP). Network interface 1148 may provide one or more connection to a data network, which may include any number of networked devices. It is appreciated that the connections via the network interface 1148 may be via a direct connection to a remote server via a direct network link to the Internet via a POP (point of presence). Network interface 1148 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 11 need not be present to practice the present disclosure. The devices and subsystems can be interconnected in different ways from that shown in FIG. 11. The operation of a computer system such as that shown in FIG. 11 is readily known in the art and is not discussed in detail in this application. Code to implement the present disclosure can be stored in computer-readable storage media such as one or more of system memory 1117, fixed disk 1144, optical disk 1142, or floppy disk 1138. The operating system provided on computer system 1100 may be MS-DOS®, MS-WINDOWS®, OS/2®, UNIX®, LINUX®, or any other operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present disclosure may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

What is claimed is:

1. A system comprising:
a data analytics module configured to process aggregated patient data to generate a report comprising relevant patient activities identified using a calculated relevance score, wherein the aggregated patient data for each patient of a plurality of patients comprises historical data associated with a respective patient and recent patient activity associated with the respective patient received from electronic devices associated with a plurality healthcare organizations, and wherein the recent patient activities are non-claim-based activities received from the electronic devices associated with the plurality healthcare organizations; and
a messaging module configured to transmit the report to an electronic device associated with one or more of the healthcare organizations responsive to the report generation.

2. The system as described in claim 1, wherein the data analytics module is further configured to hierarchically rank patients of the plurality of patients based on the calculated relevance score of recent patient activities and further based on the historical data to form a high-rank order of patients.

3. The system as described in claim 1, wherein the calculated relevance score is based on an average length of stay for a medical condition, amount of cost associated with treating the medical condition, complexity of treating the medical condition, mortality rate associated with the medical condition, or amount of follow-up care for the medical condition.

4. The system as described in claim 1, wherein the data analytics module is further configured to:
receive information from electronic devices associated with one of the healthcare organizations assigned to each patient;
aggregate the received information from the assigned healthcare organization to form an updated aggregated patient data; and
process the updated aggregated patient data to generate an updated report that hierarchically ranks patients of the plurality of patients based on the relevance score associated with the updated aggregated patient data to form a high-rank order of patients.

5. The system as described in claim 1, wherein the recent patient activity comprises admission to an emergency department (ED) of a hospital, a transfer within the hospital, or a discharge from the hospital.

6. The system as described in claim 1, wherein the assigned healthcare organization is a clinic assigned to each patient.

7. The system as described in claim 1, wherein the historical data comprises medical claim data from a center for Medicare and Medicaid Services (CMS).

8. The system as described in claim 1, wherein the recent patient activities comprises a DX summary or ED note from a hospital.

9. The system as described in claim 1, wherein the historical data comprises patient data from a home monitoring system of each patient.

10. The system as described in claim 1, further comprising a data representation module configured to render the report in a graphical user interface (GUI) in response to a user interaction with the GUI, wherein the report is interactive.

11. A system comprising:
a data store module configured to store patient data associated with a plurality of patients from a memory storage, wherein the patient data for each patient of the plurality patients comprises historical data associated with a respective patient and recent patient activity associated with the respective patient received from electronic devices associated with a plurality healthcare organizations, and wherein the recent patient activities are non-claim based activities received from the electronic devices associated with the plurality healthcare organizations;
a data analytics module configured to process the patient data to generate a report comprising recent patient activities that are actionable by the healthcare organizations; and
a messaging module configured to transmit the report to electronic devices associated with one or more of the healthcare organizations responsive to the report generation.

12. The system as described in claim 11, wherein the data analytics module is further configured to hierarchically ranking patients of the plurality of patients based on a relevance score of recent patient activities and further based on the historical data to form a high-rank order of patients.

13. The system as described in claim 12, wherein the relevance score is based on an average length of stay for a medical condition, amount of cost associated with treating the medical condition, complexity of treating the medical condition, mortality rate associated with the medical condition, or amount of follow-up care for the medical condition.

14. The system as described in claim 11, further comprising a data representation module render the report in a graphical user interface (GUI).

15. The system as described in claim 11, wherein the historical data comprises information of a medication treatment, medical plan, or medical history of the patient.

16. The system as described in claim 11, wherein the data analytics module is further configured to update the generated report in response to receiving updated patient data.

17. A system comprising:
a first electronic device configured to transmit historical data and recent activity associated with a patient; and
a second electronic device configured to process the historical data and the recent activity associated with the patient to generate a report comprising recent activities associated with the patient based on a ranking, and wherein the second electronic device is further configured to transmit the report to an electronic device of one of a plurality healthcare organizations responsive to the report generation.

18. The system as described in claim 17, wherein the ranking is based on a relevance score, wherein the relevance score is based on an average length of stay for a medical condition, amount of cost associated with treating the medical condition, complexity of treating the medical condition, mortality rate associated with the medical condition, or amount of follow-up care for the medical condition.

19. The system as described in claim 17, wherein the second electronic device is further configured to:
receiving updated recent activity associated with the patient;
modifying the report based on the updated recent activity associated with the patient responsive to receiving the updated recent activity; and
transmitting the modified report to an electronic device associated with a healthcare organization currently treating the patient.

20. The system as described in claim 17, wherein the report is transmitted to an electronic device associated with a clinic assigned to the patient.
